(19) United States
(12) Patent Application Publication
(10) Pub. No.: US 2025/0252757 A1
(43) Pub. Date: Aug. 7, 2025

(54) RECEIVING TEXT INPUT

(71) Applicant: Google LLC, Mountain View, CA (US)

(72) Inventor: Omar Estrada Diaz, Sacramento, CA (US)

(21) Appl. No.: 18/431,199

(22) Filed: Feb. 2, 2024

(51) Int. Cl. G06V 20/62; G06F 3/01; G06F 21/35; G06V 20/20; G06V 30/14; G06V 40/20

(52) U.S. Cl. CPC G06V 20/62; G06F 3/017; G06F 21/35; G06V 20/20; G06V 30/14; G06V 40/28; G06V 2201/02

(57) ABSTRACT

A non-transitory computer-readable storage medium comprises instructions stored thereon. When executed by at least one processor, the instructions cause a head-mounted device to, in response to a text-reception instruction, capture a first image; capture a second image, the second image being captured later in time than the first image; and identify text that is present in the second image and is absent from the first image

### BACKGROUND

A user of a head-mounted device may desire to enter text input into the head-mounted device. The head-mounted device may not be communicatively coupled to a keyboard, making entry input of text into the head-mounted device via the keyboard difficult.

### SUMMARY

A headset can determine text that a user is typing based on images captured by a camera. Determining the typed text based on images enables the headset to use the text as input without implementing voice recognition or communicating with a keyboard.

A user enters text into a computing device other than the head-mounted device, such as by typing into a keyboard of the computing device. The head-mounted device recognizes and/or identifies text displayed by the computing device. The head-mounted device can recognize and/or identify the typed text within multiple images captured by the head-mounted device. The recognition and/or identification of the text displayed by the computing device enables the user to input text into the head-mounted device via the keyboard of the computing device without the head-mounted device communicating with the keyboard.

According to an example, a non-transitory computer-readable storage medium comprises instructions stored thereon. When executed by at least one processor, the instructions cause a head-mounted device to, in response to a text-reception instruction, capture a first image; capture a second image, the second image being captured later in time than the first image; and identify text that is present in the second image and is absent from the first image.

According to an example, a method performed by a head-mounted device comprises, in response to a text-reception instruction, capturing a first image; capturing a second image, the second image being captured later in time than the first image; and identifying text that is present in the second image and is absent from the first image.

According to an example, a head-mounted device comprises at least one processor and a non-transitory computer-readable storage medium comprising instructions stored thereon. When executed by the at least one processor, the instructions cause the head-mounted device to, in response to a text-reception instruction, capture a first image; capture a second image, the second image being captured later in time than the first image; and identify text that is present in the second image and is absent from the first image.

The details of one or more implementations are set forth in the accompanying drawings and the description below. Other features will be apparent from the description and drawings, and from the claims.

### BRIEF DESCRIPTION OF THE DRAWINGS

FIG. 1 shows a user wearing a head-mounted device and inputting text into a computing device.

FIGS. 2A through 2E show text captured by the head-mounted device.

FIG. 3 is a block diagram of a computing system.

FIGS. 4A, 4B, and 4C show an example of a head-mounted device.

FIG. 5 is a flowchart showing a method performed by the head-mounted device.

Like reference numbers refer to like elements.

### DETAILED DESCRIPTION

A user may desire to input text into a head-mounted device worn by the user. The user may desire not to input the text by voice due to a desire for privacy or noisy conditions. The user may have access to a computing device (which is not the head-mounted device) with a keyboard for entering text into the computing device. A technical problem with entering text into the head-mounted device via the keyboard is that the head-mounted device may not be communicatively coupled to the computing device that has the keyboard.

A technical solution to the technical problem of the head-mounted device not being communicatively coupled to the computing device is for the head-mounted device to receive and/or process text input by recognizing and/or identifying text and/or characters outputted by the computing device. The head-mounted device can recognize and/or identify the text and/or characters within images of an output, such as a display, of the computing device that are captured by the head-mounted device. In some implementations, the head-mounted device may use the position of a cursor in the image to determine what text to recognize and/or identify. In some implementations, the head-mounted device may use a comparison of at least two images to identify text added between the images (e.g., a first image and a second image). A technical benefit of this technical solution is that the head-mounted device can receive text input without being communicatively coupled to a keyboard.

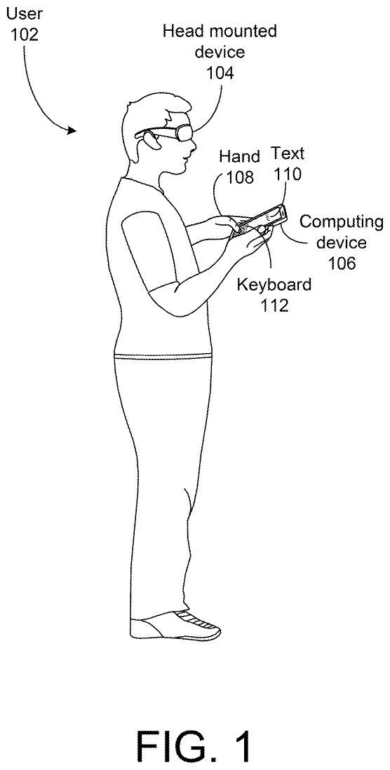

FIG. 1 shows a user 102 wearing a head-mounted device 104 and inputting text 110 into a computing device 106. The user 102 can wear the head-mounted device 104 on a head of the user 102. In some examples, the head-mounted device 104 includes an augmented reality headset that includes at least one camera for capturing images in front of the user 102 and at least one display for presenting graphical output on a lens of the head-mounted device 104. In some examples, the head-mounted device 104 includes a virtual reality headset that includes at least one camera for capturing images in front of the user 102 and at least one display for presenting graphical output to the user 102.

The user 102 may desire to input text into the head-mounted device 104. The user 102 may be able to input text into a keyboard 112 of another computing device, such as the computing device 106. The keyboard 112 can be included in, and/or communicatively coupled to, the computing device 106. In the example shown in FIG. 1, the computing device 106 is a smartphone and the keyboard 112 is a soft keyboard generated by a touchscreen display included in the computing device 106. This is merely an example. In some examples, the computing device can include a touchscreen display with a soft keyboard. In some examples, the keyboard can be a hard keyboard with physical keys and the keyboard can be communicatively coupled to the computing device via a wired interface such as Universal Serial Bus (USB) or a wireless interface such as Bluetooth, such as a keyboard for a tablet and/or a laptop.

The user 102 can input text into the computing device 106. The text that the user inputs into the computing device 106 can be a sequence of alphanumeric characters. The user 102 can input the text via the keyboard 112, such as by pressing and/or tapping keys included in the keyboard 112. The user 102 can press and/or tap the keys with fingers of a hand 108 of the user 102.

The computing device 106 can respond to the user 102 inputting the text by outputting text 110 on a display included in and/or coupled to the computing device 106. The computing device 106 can output the text 110 character by character, in a chronological order corresponding to the order in which the user 102 inputted the characters. The computing device 106 can spatially arrange the characters based on the chronological order in which the user 102 inputted the characters into the keyboard 112.

A camera included in the head-mounted device 104 can capture images of the display that outputs and/or presents the text 110. The images captured by the camera included in the head-mounted device 104 can include the text 110. The head-mounted device 104 can recognize and/or identify text based on the captured images. The head-mounted device 104 can recognize and/or identify the text by applying one or more optical character recognition (OCR) algorithms.

The head-mounted device 104 can capture the images of the display that outputs and/or presents the text 110, and/or recognize and/or identify text based on the captured images, in response to a text-reception instruction. The text-reception instruction can be an instruction for the head-mounted device 104 to begin an operation that receives and/or inputs (recognizes and/or identifies) text from an external display, such as a display of the computing device 106.

In some examples, the head-mounted device 104 generates the text-reception instruction in response to recognizing and/or identifying a cursor on the display of the computing device 106. In some implementations, the head-mounted device 104 can recognize and/or identify the cursor in response to the text-reception instruction. The cursor can be a blinking line or box that the head-mounted device 104 recognizes and/or identifies as a cursor. The head-mounted device 104 can recognize and/or identify the cursor as indicating that the user 102 will begin typing into the computing device 106 and/or keyboard 112.

In some examples, the head-mounted device 104 generates the text-reception instruction in response to recognizing and/or identifying one or more typing motions by the hand 108 of the user 102. The head-mounted device 104 can recognize and/or identify the one or more typing motions by comparing images of the hand 108 captured by the head-mounted device 104 to one or more gestures stored as a typing gesture in a gesture library included in the head-mounted device 104. The typing motions can include thumb movements above a plane (the plane can correspond to a touchscreen display), or finger movements associated with movements of fingers along a keyboard.

In some examples, the head-mounted device 104 generates the text-reception instruction in response to recognition and/or identification of a gesture. The gesture that the head-mounted device 104 recognizes and/or identifies can be a gesture associated with inputting text that is stored by the head-mounted device 104 in a gesture library. The gesture can be hand and/or finger movements in a shape of a letter, or a typing motion, as non-limiting examples.

In some examples, the head-mounted device 104 can generate the text-reception instruction in response to recognition and/or identification of the hand 108 being proximal to the keyboard 112. The head-mounted device 104 can recognize and/or identify the hand 108 as being proximal to the keyboard 112 based on recognizing and/or identifying the hand 108 as a hand, recognizing and/or identifying the keyboard 112 as a keyboard, and determining that a distance between the hand 108 and the keyboard 112 satisfies a proximity threshold. The proximity threshold can be within one centimeter, or the hand 108 being in contact with the keyboard 112, as non-limiting examples.

After generating the text-reception instruction, the head-mounted device 104 captures images. The head-mounted device 104 can capture the images via one or more cameras included in the head-mounted device 104. The images can include the display that includes the text 110. The images can include a first image and a second image, the second image being later in time than the first image. The head-mounted device 104 can recognize and/or identify text based on the images. The head-mounted device 104 can, for example, recognize and/or identify text that is present in the second (or subsequent) image and is absent from the first (or previous) image.

The head-mounted device 104 can perform an action based on the text that the head-mounted device 104 recognized and/or identified. In some examples, the head-mounted device 104 can authenticate the head-mounted device 104 with another computing device (other than the computing device 106) based on the text, such as sending the text as a passcode to access a wireless local area network (WLAN) or pairing the head-mounted device 104 with the another computing device such as according to a Bluetooth protocol. In some examples, the head-mounted device 104 can generate an electronic message, such as a text message or email message, that includes the text. The head-mounted device 104 can send the electronic message to another computing device.

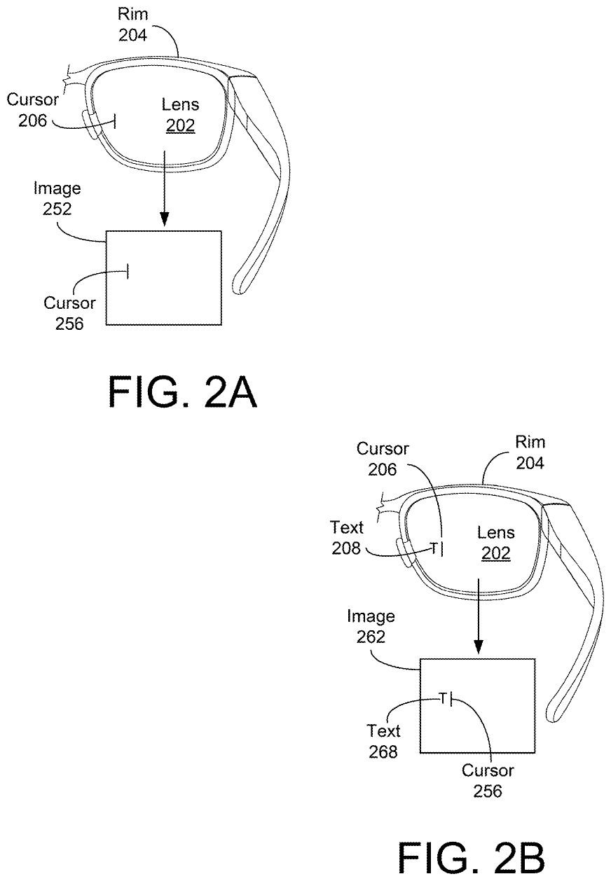

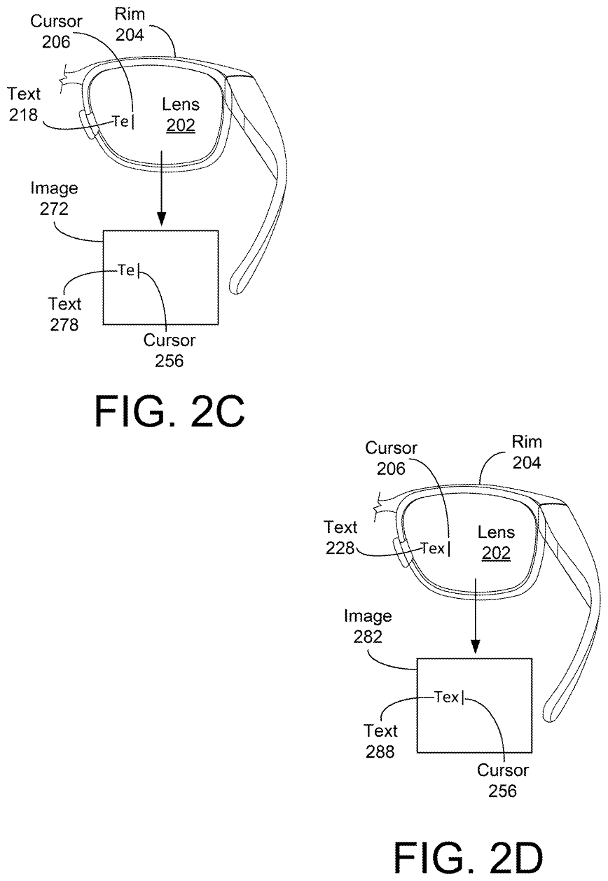

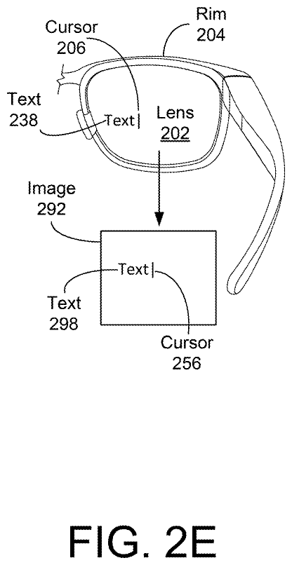

FIGS. 2A through 2E show text captured by the head-mounted device 104. The left sides of FIGS. 2A through 2E show a perspective from a right eye of a user and/or behind a rim 204 and lens 202 included in the head-mounted device 104. The right sides of FIGS. 2A through 2E show images 252, 262, 272, 282, 292 captured by a camera included in the head-mounted device 104. The images 252, 262, 272, 282, 292 include a portion of the display included in the computing device 106. The portion of the display included in the images 252, 262, 272, 282, 292 includes text.

As shown in FIG. 2A, the display of the computing device 106 presents a cursor 206. The cursor 206 is captured by the camera and included in image 252 as cursor 256. The cursor 206 can include a blinking line, a blinking box, blinking object, or other object for which a brightness periodically changes. In some examples, the head-mounted device 104 recognizes and/or identifies the cursor 206 as a cursor. In response to recognizing and/or identifying the cursor 206 as a cursor, the head-mounted device 104 generates a text-reception instruction. The text-reception instruction can cause the head-mounted device 104 to capture, recognize, and/or identify text.

As shown in FIG. 2B, the computing device 106 has generated and/or displayed a character, “T”, as text 208. The image 262 captured by the camera included in the head-mounted device 104 includes the single character, “T”, as text 268. The cursor 206, 256 is still present and displayed subsequent to the text 208, 268. In some examples, the computing device 106 recognizes and/or identifies the character, “T”, as text, based on the character “T” being included in text 268 within the image 262 but not in the image 252.

As shown in FIG. 2C, the computing device 106 has generated and/or displayed characters, “Te”, as text 218. The image 272 captured by the camera included in the head-mounted device 104 includes the characters, “Te”, as text 278. The cursor 206, 256 is still present and displayed subsequent to the text 218, 278. In some examples, the computing device 106 recognizes and/or identifies the character, “e”, as text, based on the character “e” being included in text 278 within the image 272 but not in the image 262.

As shown in FIG. 2D, the computing device 106 has generated and/or displayed characters, “Tex”, as text 228. The image 282 captured by the camera included in the head-mounted device 104 includes the characters, “Tex”, as text 288. The cursor 206, 256 is still present and displayed subsequent to the text 228, 288. In some examples, the computing device 106 recognizes and/or identify the character, “x”, as text, based on the character “x” being included in text 288 within the image 282 but not in the image 272.

As shown in FIG. 2E, the computing device 106 has generated and/or displayed characters, “Text”, as text 238. The image 292 captured by the camera included in the head-mounted device 104 includes the characters, “Text”, as text 298. The cursor 206, 256 is still present and displayed subsequent to the text 238, 298. In some examples, the computing device 106 recognizes and/or identifies the character, “t”, as text, based on the character “t” being included in text 298 within the image 292 but not in the image 282. In some examples, the computing device 106 recognizes and/or identifies the string of characters, “Text”, as text, based on the characters “Text” being included in text 298 within the image 292 but not in the image 252 that initially included the cursor 256 that caused the head-mounted device 104 to generate the text-reception instruction.

In some examples, the head-mounted device 104 ends reception, identification, and/or recognition and/or identification of text after a predetermined period of time has elapsed with no new characters being recognized. In some examples, the head-mounted device 104 ends reception, identification, and/or recognition of text in response to a voice command. In some examples, the head-mounted device 104 ends reception, identification, and/or recognition of text in response to recognizing and/or identifying a predetermined gesture. In some examples, the head-mounted device 104 ends reception, identification, and/or recognition of text in response to a touch input and/or button input on the head-mounted device 104. In some examples, the head-mounted device 104 ends reception, identification, and/or recognition of text in response to recognizing and/or identifying a predetermined sequence of characters, which can be considered a specific “token” word, within the text.

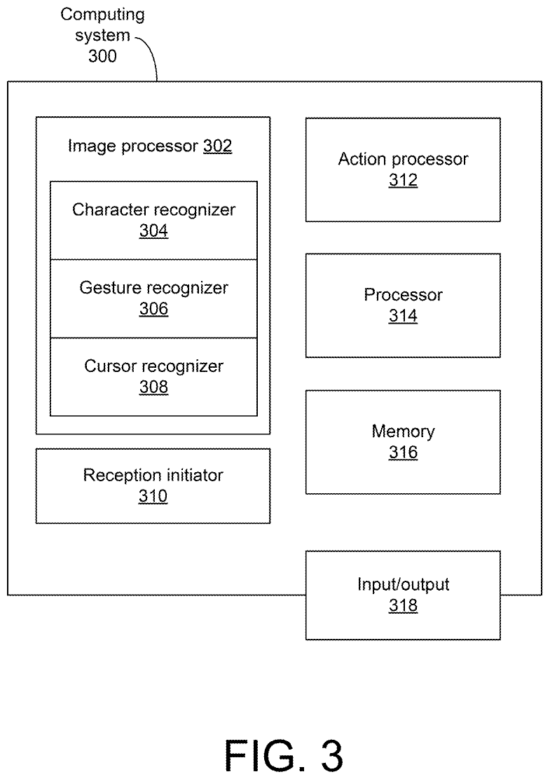

FIG. 3 is a block diagram of a computing system 300. The computing system 300 can implement methods, functions, and/or techniques performed by the head-mounted device 104 and a computing device in communication with the head-mounted device 104, and/or methods, functions, and/or techniques distributed between the head-mounted device 104 and a computing device in communication with the head-mounted device 104.

The computing system 300 can include an image processor 302. The image processor 302 can process images, such as images 252, 262, 272, 282, 292, captured by a camera included in and/or in communication with the computing system 300. The image processor 302 can include image recognition and/or identification features that recognize and/or identify objects and/or gestures.

The image processor 302 can include a character recognizer 304. The character recognizer 304 can recognize and/or identify characters, such as alphanumeric characters. The character recognizer 304 can recognize and/or identify characters by performing an optical character recognition (OCR) algorithm. The alphanumeric characters recognized and/or identified by the recognizer 304 can be characters inputted into a keyboard such as the keyboard 112 and/or displayed by a computing device such as the computing device 106. The text 208, 218, 228, 238, 268, 278, 288, 298 includes examples of characters that the character recognizer 304 can recognize and/or identify. In some examples, the character recognizer 304 recognizes and/or identifies characters that are included in a current images and were absent from a previous image. In some examples, the character recognizer 304 recognizes and/or identifies a character that is adjacent to and/or proximal to a cursor 256.

The image processor 302 can include a gesture recognizer 306. The gesture recognizer 306 can recognize and/or identify gestures, such as gestures performed by a hand of a user such as the hand 108 of the user 102. The gesture recognizer 306 can recognize and/or identify gestures by classifying movements of a hand or other body part and comparing the classified movements to movements stored in a gesture library. If the comparison satisfies a similarity threshold for a movement stored in the gesture library, then the gesture recognizer 306 can determine that a gesture for which the similarity threshold was satisfied was performed. Gestures can include, for example, typing movements or hand placement indicating that the hand is on a soft keyboard or physical keyboard. The gesture recognizer 306 can prompt a reception initiator 310 to generate a text-reception instruction based on recognition and/or identification of a gesture associated with receiving text.

The image processor 302 can include a cursor recognizer 308. The cursor recognizer 308 can recognize and/or identify a cursor on a display. The cursor recognizer 308 can recognize and/or identify a cursor on a display based on an image captured by the computing system 300, such as any of the images 252, 262, 272, 282, 292 that include the cursor 256. The cursor recognizer 308 can recognize and/or identify a cursor based on an image and/or sequence of images including an object that satisfies a similarity threshold to a cursor pattern stored in the computing system 300. The cursor pattern can include, for example, a flashing or blinking line, a flashing or blinking vertical box, or another object with a periodic pattern of increasing and decreasing brightness. In some examples, the periodic pattern of blinking, flashing, and/or increasing and decreasing can be within a range of frequencies, such as between one Hertz (1 Hz) and two Hertz (2 Hz). The cursor recognizer 308 can prompt the reception initiator 310 to generate a text-reception instruction based on recognition and/or identification of the cursor.

The computing system 300 can include a reception initiator 310. The reception initiator 310 can cause the computing system 300 to initiate reception of text. Reception of text can include capturing images and/or recognizing and/or identifying text within the captured image. In some examples, the reception initiator 310 can cause the computing system 300 to initiate reception, identification, and/or recognition of text based on the gesture recognizer 306 recognizing and/or identifying a gesture that is associated with receiving and/or processing text. In some examples, the reception initiator 310 can cause the computing system 300 to initiate reception, identification, and/or recognition of text based on the cursor recognizer 308 recognizing and/or identifying a cursor. In some examples, the head-mounted device 104 initiates reception, identification, and/or recognition of text in response to a voice command. In some examples, the head-mounted device 104 initiates reception, identification, and/or recognition of text in response to a touch input and/or button input on the head-mounted device 104.

The computing system 300 can include an action processor 312. The action processor 312 can cause the computing system 300 to perform an action based on text that the computing system 300 recognized and/or identified. In some examples, the action processor 312 can cause the computing system 300 to authenticate the computing system 300 with another computing device, such as by entering a password or pairing with the other computing device, based on the recognized and/or identified text. In some examples, the action processor 312 can cause the computing system 300 to send an electronic message, such as an email or text message, that includes the recognized and/or identified text.

The computing system 300 can include at least one processor 314. The at least one processor 314 can execute instructions, such as instructions stored in at least one memory device 316, to cause the computing system 300 to perform any combination of methods, functions, and/or techniques described herein.

The computing system 300 can include at least one memory device 316. The at least one memory device 316 can include a non-transitory computer-readable storage medium. The at least one memory device 316 can store data and instructions thereon that, when executed by at least one processor, such as the processor 314, are configured to cause the computing system 300 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 300 can be configured to perform, alone, or in combination with another computing device such as the computing device 106 and/or a server in communication with the computing system 300 and/or head-mounted device 104, any combination of methods, functions, and/or techniques described herein.

The computing system 300 may include at least one input/output node 318. The at least one input/output node 318 may receive and/or send data, such as from and/or to, another computer, and/or may receive input and provide output from and to a user such as the user 102. The input and output functions may be combined into a single node, or may be divided into separate input and output nodes. The input/output node 318 can include, for example, a microphone, a camera, an inertial measurement unit (IMU), a display, a speaker, a microphone, one or more buttons, and/or one or more wired or wireless interfaces for communicating with other computing devices.

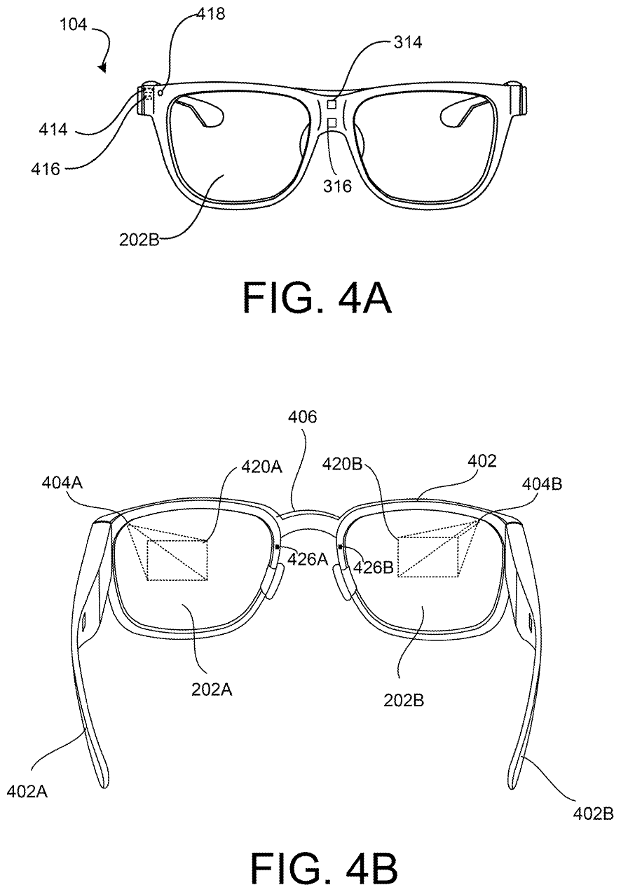

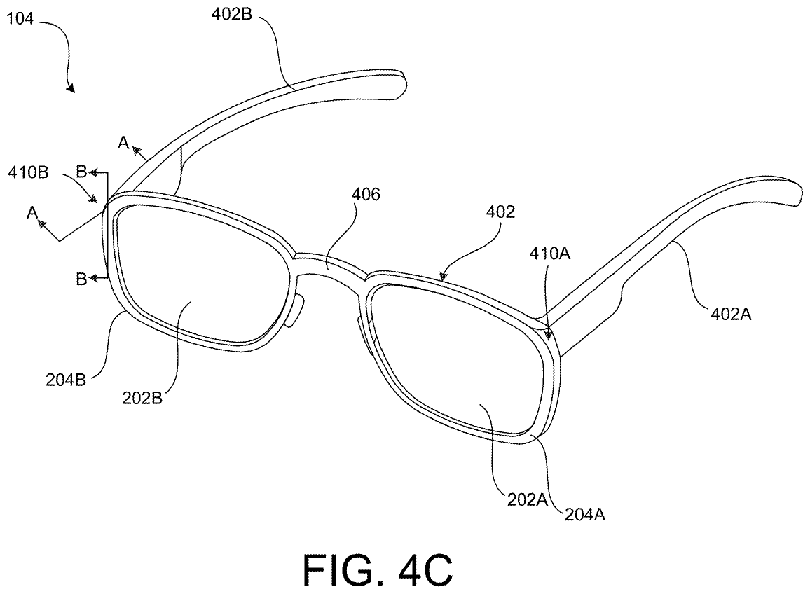

FIGS. 4A, 4B, and 4C show an example of a head-mounted device 104. FIGS. 4A, 4B, and 4C show an example of the head-mounted device 104. As shown in FIGS. 4A, 4B, and 4C, the example head-mounted device 104 includes a frame 402. The frame 402 includes a front frame portion defined by rim portions 204A, 204B surrounding respective optical portions in the form of lenses 202A, 202B, with a bridge portion 406 connecting the rim portions 204A, 204B. Arm portions 402A, 402B included in the frame 402 are coupled, for example, pivotably or rotatably coupled, to the front frame by hinge portions 410A, 410B at the respective rim portions 204A, 204B. In some examples, the lenses 202A, 202B may be corrective/prescription lenses. In some examples, the lenses 202A, 202B may be an optical material including glass and/or plastic portions that do not necessarily incorporate corrective/prescription parameters. Displays 404A, 404B may be coupled in a portion of the frame 402. In the example shown in FIG. 4B, the displays 404A, 404B are coupled in the arm portions 402A, 402B and/or rim portions 204A, 204B of the frame 402. In some examples, the head-mounted device 104 can also include an audio output device 416 (such as, for example, one or more speakers), an illumination device 418, at least one processor 314, at least one memory device 316, an outward-facing image sensor 414 (or camera), and/or gaze-tracking cameras 426A, 426B that can capture images of eyes of the user 102 to track a gaze of the user 102. The at least one processor 314 can execute instructions. The at least one memory device 316 can include a non-transitory computer-readable storage medium comprising instructions stored thereon that, when executed by the at least one processor 314, are configured to cause the head-mounted device 104 to perform any combination of methods, functions, and/or techniques described herein.

In some examples, the head-mounted device 104 may include a see-through near-eye display. For example, the displays 404A, 404B may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 202A, 202B, next to content (for example, digital images, user interface elements, virtual content, and/or virtual objects) generated by the displays 404A, 404B. In some implementations, waveguide optics may be used to depict content on and/or by the displays 404A, 404B via outcoupled light. The images 420A, 420B projected by the displays 404A, 404B onto the lenses 202A, 202B may be translucent, allowing the user 102 to see the images projected by the displays 404A, 404B as well as physical objects beyond the head-mounted device 104.

In the example shown in FIG. 4C, the head-mounted device 104 includes lenses 202A, 202B supported by the frame 402. The lenses 202A, 202B can be supported by respective rim portions 204A, 204B that are included in the frame 402. In some examples, the lenses 202A, 202B, in conjunction with the displays 404A, 404B, present, to the user 102, images generated by the processor 314. The rim portion 204A can be coupled to rim portion 204B via the bridge portion 406.

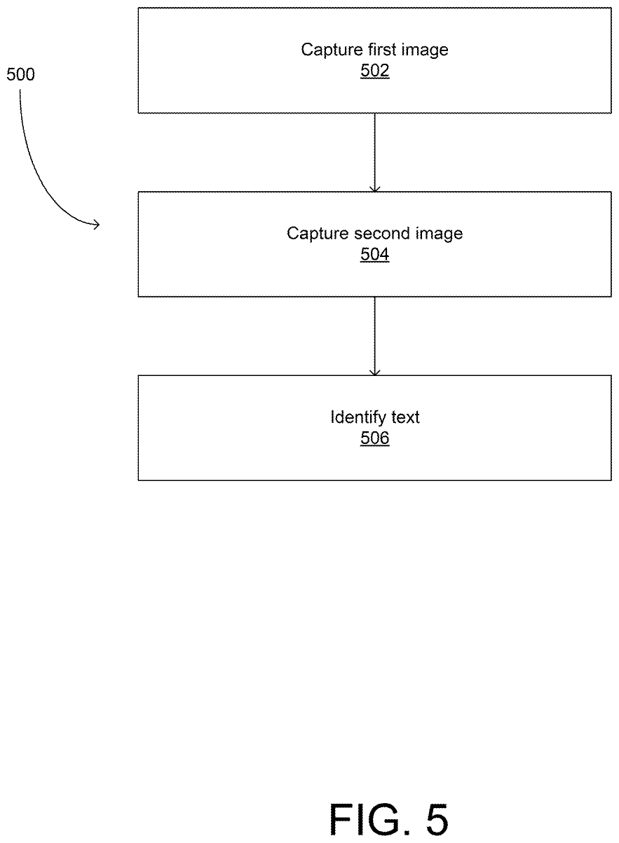

FIG. 5 is a flowchart showing a method 500 performed by the head-mounted device 104. The method can include capturing a first image (502). Capturing the first image (502) can include, in response to a text-reception instruction, capturing a first image. The method 500 can include capturing a second image (504). Capturing the second image (504) can include capturing a second image, the second image being captured later in time than the first image. The method can include identifying text (506). Identifying text (506) can include identifying text that is present in the second image and is absent from the first image.

In some examples, the text-reception instruction is generated in response to identifying a cursor.

In some examples, the text-reception instruction is generated in response to identification of a typing motion by a hand.

In some examples, the text-reception instruction is generated in response to identification of a gesture.

In some examples, the text-reception instruction is generated in response to identification of a hand proximal to a keyboard.

In some examples, the method 500 further includes authenticating the head-mounted device with another computing device based on the text.

In some examples, the method 500 further includes sending an electronic message, the electronic message including the text.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the disclosure.

1. A non-transitory computer-readable storage medium comprising instructions stored thereon that, when executed by at least one processor, cause a head-mounted device to:
in response to a text-reception instruction, capture a first image;
capture a second image;
identify text that is present in the second image and is absent from the first image by comparing the first image to the second image and identifying the text as added between the first image and the second image; and
perform an action based on identifying the text.

2. The non-transitory computer-readable storage medium of claim 1, wherein the text-reception instruction is generated in response to identifying a cursor.

3. The non-transitory computer-readable storage medium of claim 1, wherein the text-reception instruction is generated in response to identification of a typing motion by a hand.

4. The non-transitory computer-readable storage medium of claim 1, wherein the text-reception instruction is generated in response to identification of a gesture.

5. The non-transitory computer-readable storage medium of claim 1, wherein the text-reception instruction is generated in response to identification of a hand proximal to a keyboard.

6. The non-transitory computer-readable storage medium of claim 1, wherein the action includes authenticating the head-mounted device with another computing device based on the text.

7. The non-transitory computer-readable storage medium of claim 1, wherein the action includes sending an electronic message, the electronic message including the text.

8. A method performed by a head-mounted device, the method comprising:
in response to a text-reception instruction, capturing a first image;
capturing a second image, the second image being captured after the first image;
identifying text that is present in the second image and is absent from the first image; and
performing an action based on identifying the text.

9. The method of claim 8, wherein the text-reception instruction is generated in response to identifying a cursor.

10. The method of claim 8, wherein the text-reception instruction is generated in response to identification of a typing motion by a hand.

11. The method of claim 8, wherein the text-reception instruction is generated in response to identification of a gesture.

12. The method of claim 8, wherein the text-reception instruction is generated in response to identification of a hand proximal to a keyboard.

13. The method of claim 8, wherein the action includes authenticating the head-mounted device with another computing device based on the text.

14. The method of claim 8, wherein the action includes sending an electronic message, the electronic message including the text.

15. A head-mounted device comprising:
at least one processor; and
a non-transitory computer-readable storage medium comprising instructions stored thereon that, when executed by the at least one processor, cause the head-mounted device to:
in response to a text-reception instruction, capture a first image;
capture a second image, the second image being captured after the first image;
identify text that is present in the second image and is absent from the first image by comparing the first image to the second image and identifying the text as added between the first image and the second image; and
perform an action based on identifying the text.

16. The head-mounted device of claim 15, wherein the text-reception instruction is generated in response to identifying a cursor.

17. (canceled)

18. The head-mounted device of claim 15, wherein the text-reception instruction is generated in response to identification of a gesture.

19. The head-mounted device of claim 15, wherein the text-reception instruction is generated in response to identification of a hand proximal to a keyboard.

20. The head-mounted device of claim 15, wherein the action includes authenticating the head-mounted device with another computing device based on the text.

21. The non-transitory computer-readable storage medium of claim 1, wherein:
the text-reception instruction is generated in response to the head-mounted device identifying a cursor, the cursor being included in a cursor image that was captured by a camera included in the head-mounted device;
the second image is captured after the first image;
the identification of the text is performed in response to the text-reception instruction;
the action includes authenticating the head-mounted device with an other computing device by sending the text as a passcode to the other computing device; and
the head-mounted device is not communicatively coupled to the other computing device.
